(19) United States
(12) Patent Application Publication
(10) Pub. No.: US 2006/0261882 A1
(43) Pub. Date: Nov. 23, 2006

(54) Bandgap generator providing low-voltage operation

(76) Inventor: Phillip Johnson, Allentown, PA (US)

Correspondence Address: MENDELSOHN AND ASSOCIATES, P.C., 1500 JOHN F. KENNEDY BLVD., SUTIE 405, PHILADELPHIA, PA, 19102, US

(21) Appl. No.: 11/131,053

(22) Filed: May 17, 2005

(51) Int. Cl. G05F 1/10

(52) U.S. Cl. 327/539

(57) ABSTRACT

A bandgap reference circuit uses a pair of parallel loads and an op-amp driver circuit. The op-amp driver circuit uses NMOS inputs to sense voltage conditions at the loads. The configuration permits low-voltage response at low temperatures as a result of the configuration setting operating voltages above a saturation voltage. The op-amp driver provides an NMOS output, and a low-gain stage converts the NMOS output to an output corresponding to that of a conventional PMOS design.

### TECHNICAL FIELD

This invention relates to a bandgap reference circuit that operates at low-voltage. More particularly the invention relates to providing low voltage functionality in the generation of a bandgap compensating voltage used for operating a reference generator.

### BACKGROUND

Bandgap reference circuits include circuitry for providing a bandgap compensating voltage. One technique is to use an op amp to generate a temperature-compensated output voltage in accordance with a bandgap of a bipolar device, in which the temperature-compensated output voltage is used as the bandgap compensating voltage. The bandgap compensating voltage is then used to provide a voltage-stabilized reference voltage and/or stable current source.

FIG. 1 is a schematic block diagram showing a prior art bandgap reference circuit 10, comprising a bandgap core stage 11, a bandgap generator stage 21, and a current generator stage 31. A description of an exemplary bandgap reference circuit of this type is found in FIG. 1 of U.S. Pat. No. 6,710,641 to Yu, et al., the teachings of which are incorporated by reference herein. Bandgap reference circuit 10 provides bandgap reference voltage under conditions of varied supply voltage and/or temperature over a predetermined range of temperatures. Bandgap core stage 11 provides a bandgap compensating voltage to bandgap generator stage 21, which in turn provides a reference voltage for current generator stage 31.

FIG. 2 is a schematic diagram of bandgap core stage 11 of FIG. 1. Core stage 11 uses a driver op amp 233, which changes its output in response to a control circuit 235. As current changes in the control circuit 235, a pair of parallel loads 238, 239 in the control circuit changes corresponding control outputs 248, 249 provided to driver op amp 233. Load 238 includes a current source transistor P_{SRC0} connected in series with a load resistor 251 and a bipolar load transistor Q0. Load 239 includes a current source transistor P_{SRC1} connected in series with a bipolar load transistor Q1. Transistors P_{SRC0} and P_{SRC1} are gated by an output of driver op amp 233, which causes the current through loads 238, 239 to fluctuate responsive to change in source voltage V_{CC} (i.e., a high reference voltage) and an output voltage V_{OUT}. Bipolar load transistor Q0 has device parameters that result in a lower impedance than that of bipolar load transistor Q1, with the lower impedance balanced by load resistor 251. When current changes across bipolar load transistor Q0, current across load resistor 251 increases or decreases correspondingly. The use of temperature-dependant bipolar transistors in loads 238, 239 results in a temperature compensation that is incorporated into the output voltage V_{OUT} of core stage 11. Output voltage V_{OUT} is the bandgap compensating voltage.

Driver op amp 233 includes two p-type transistors P_{POS} and P_{NEG}, connected in series to two n-type transistors N_{SRC} and N_{DIO}, in respective parallel circuits. Driver amp senses loads 238, 239 by virtue of connections of control outputs 248, 249 to the respective gates of transistors P_{POS} and P_{NEG}. The use of the two p-type transistors P_{POS} and P_{NEG} responsive to loads 238, 239 present a PMOS input configuration for driver op amp 233. Driver op amp 233 is referenced to V_{CC}, and controls an output transistor N_{OUT} in response to the voltages from loads 238, 239 as sensed by transistors P_{POS} and P_{NEG}. When current across load resistor 251 increases or decreases, this results in a corresponding increase or decrease in the voltage at control output 248, and consequently changes the gate voltage at transistor P_{POS}. Transistor P_{NEG} is gated by voltage from control output 249, and transistors N_{SRC} and N_{DIO} are gated by node 263.

Transistor P_{SRC2} is connected between source (V_{CC}) and a node PDIFF, and is gated by the output voltage V_{OUT} of core stage 11. This provides the reference of driver op amp 233 to V_{CC} and adjusts this reference by V_{OUT}. Node PDIFF is connected to the parallel circuits established by P_{POS}, P_{NEG}, N_{SRC}, and N_{DIO}, with transistors P_{POS} and P_{NEG} receiving source current from node PDIFF. Node PDIFF therefore represents a difference between the impedance at transistor P_{SRC2} and the combined impedance of transistors P_{POS}, P_{NEG}, N_{SRC}, and N_{DIO}. The combination of current flows through transistors P_{SRC2}, P_{POS}, P_{NEG}, N_{SRC}, and N_{DIO} results in an adjustment of the voltage at node 271, which in turn controls the gating of transistor N_{OUT}. As temperature across the bipolar transistors Q0 and Q1 changes, the balance of control outputs 248, 249 changes, thereby differentially controlling transistors P_{POS} and P_{NEG} such that the voltage at node 271 increases with an increase in temperature and decreases with a decrease in temperature.

Transistor N_{OUT} cooperates with transistor P_{DIO} to establish the voltage of node 275, which is the output voltage V_{OUT} of core stage 11 and is also used to simultaneously gate transistors P_{SRC0} and P_{SRC1}. This results in node 275 decreasing in voltage with increased temperature and increasing in voltage with decreased temperature.

V_{OUT} is in turn supplied to bandgap generator stage 290, which corresponds to bandgap generator stage 21 of FIG. 1. Bandgap generator stage 290 includes control transistor 291 in series with a parallel connection of bipolar transistor 293 and compensating resistor 295. As can be seen, the configuration of transistor 291 in series with bipolar transistor 293 is similar to that of loads 238, 239. Core stage 11 adjusts V_{OUT} so as to compensate for temperature effects on bipolar transistor 293. As a result, the voltage at output V_{BG} remains constant over the specified temperature range.

In this device, transistors P_{POS} and P_{NEG} are gated by voltages controlled by bipolar transistors Q0 and Q1, respectively. Therefore, bipolar transistors Q0 and Q1 must have base to emitter voltages (V_{BE}) at a particular level to operate, which can be stated as:
V_{CC min}=V_{BE}+V_{PGS}+V_{PSAT} (equation 1)
where:
V_{CC min} is the minimum value of power supply V_{CC} at which bandgap core stage 11 will function properly,
V_{PGS} is the saturation voltage of transistors P_{POS} and P_{NEG}, and
V_{PSAT} is the saturation voltage across transistor P_{SRC2},
   In terms of the circuit, equation 1 becomes:
   V_{CC min}(V_{BE} Q0+V_{RESISTOR 251})+V_{PGS}+V_{PSAT} (equation 2a)
   and
   V_{CC min}=V_{BE}Q1+V_{PGS}+V_{PSAT} (equation 2b)
   where
V_{BE} Q0 and V_{BE} Q1 are the voltages across the respective transistors, and
V_{RESISTOR 251} is the voltage drop across resistor 251, so that:
   (V_{BE} Q0+V_{RESISTOR 251})=voltage applied to the gate of transistor P_{POS} (equation 3a)
   V_{BE}Q1=voltage applied to the gate of transistor P_{NEG} (equation 3b)
   Therefore:
   V_{BE}Q0=V_{CC min}−(V_{PGS}+V_{PSAT}+V_{RESISTOR 251}) (equation 4a)
   and
   V_{BE}Q1=V_{CC min}−(V_{PGS}+V_{PSAT}) (equation 4b)

In terms of the circuit, in order for the circuit to respond to the loads 238, 239, the voltage across transistor P_{SRC2} plus V_{PGS} of transistor P_{NEG} must be less than V_{CC} minus V_{BE} Q1. Similar considerations also apply to load 238. If that is not the case, then at least one of transistors P_{SRC2}, P_{POS}, or P_{NEG} will cease to conduct, and the circuit will then not provide the desired output voltage V_{OUT}. This condition occurs when V_{BE} of transistor Q0 or Q1 increases. For the same reasons, an op amp with PMOS inputs of this type will cease to function properly when the output voltage V_{OUT} of core stage 11 decreases to approach the source or supply voltage V_{CC}.

These limitations are depicted by FIG. 3, which is a graphical representation of PNP voltage over temperature. As can be seen on the right side of the graph, at higher temperatures the minimum PNP voltage is in the range of 0.5 volts. At cooler temperatures (e.g., −40° C.), the PNP voltage exceeds 0.7 volts. Applying equation 4a or 4b, the minimum supply voltage V_{CC MIN} for operation at −40° C. is given by:
V_{CC min}=0.77+0.26+0.05=1.08 (equation 5)
where
(V_{BE}Q0+V_{RESISTOR 251}) and V_{BE}Q1=0.77v
V_{PGS}=voltage across transistors P_{POS} and P_{NEG}=0.26v
V_{PSAT}=voltage across transistor P_{SRC2}=0.05v

In the example, if the supply voltage V_{CC} is below 1.08 volts, then the circuit does not work properly.

### SUMMARY

In one embodiment, the present invention is a bandgap reference circuit that uses a pair of parallel reference loads to control a driver op amp stage in order to generate a reference voltage. The driver op amp receives inputs from the parallel reference loads. The driver op amp is configured with NMOS inputs and, operates by establishing a difference node on the ground side of the inputs. The driver op amp provides a sensed difference output corresponding to the difference between the inputs received from the parallel reference loads. A circuit converts the op amp output to the reference voltage by converting the op amp output to an output referenced to a source level.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 is a block diagram showing a prior art bandgap reference circuit.

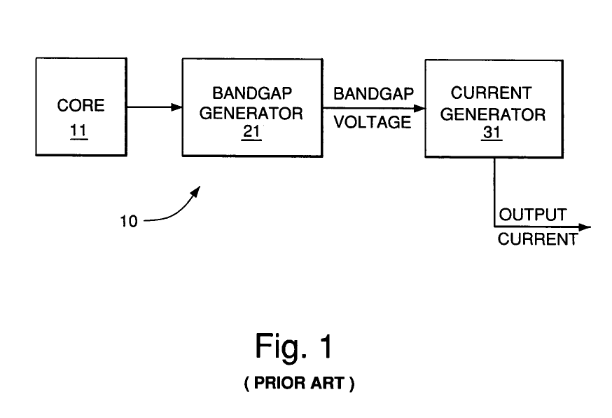

FIG. 2 is a schematic diagram of the bandgap core stage of the bandgap reference circuit of FIG. 1.

FIG. 3 is a graphical representation of PNP voltage over temperature.

FIG. 4 is a schematic diagram of an exemplary bandgap core stage of the present invention.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments.

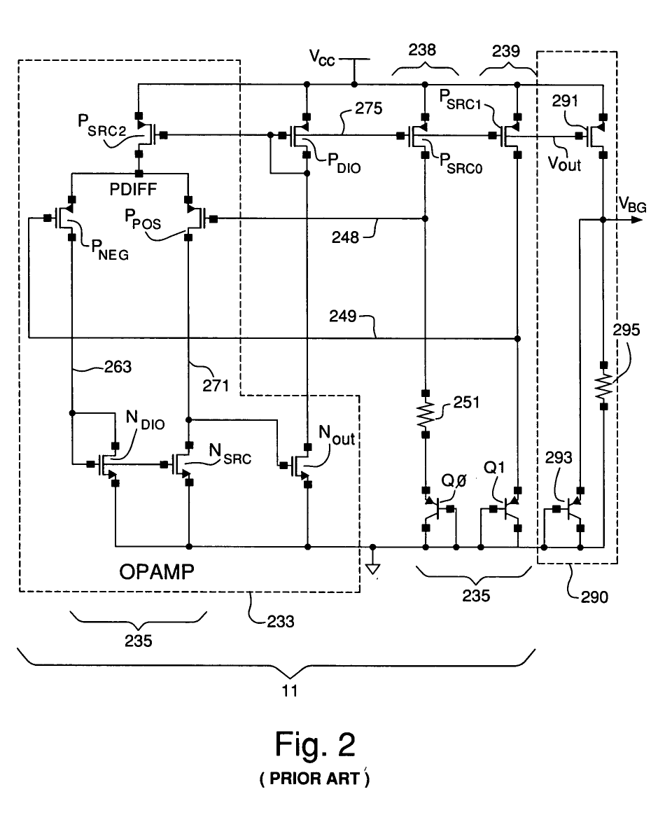

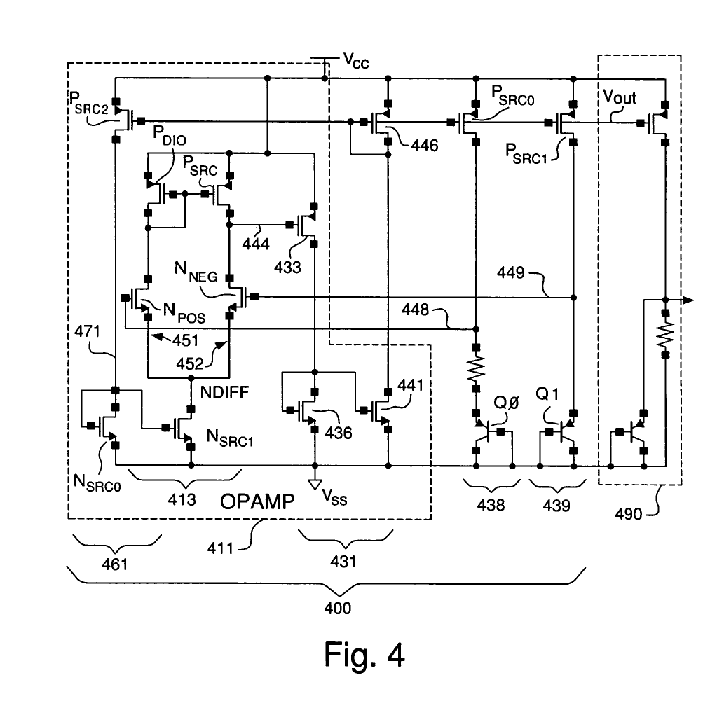

FIG. 4 is a schematic diagram of an exemplary bandgap core stage 400 of the present invention. As is the case with the circuit of FIG. 2, core stage 400 uses parallel loads 438, 439 to control driver op amp 411 through a control circuit 413 (which comprises N_{POS}, N_{NEG}, P_{DIO}, P_{SRC}, and N_{SRC1}); however, in the present configuration, control circuit 413 is referenced to V_{SS} (e.g., ground or other low reference voltage) instead of being referenced to V_{CC}. By referencing control circuit 413 to ground (V_{SS}), core stage 400 can operate without the minimum voltage restrictions of the prior art in the low-temperature range. This is accomplished by using NMOS inputs in control circuit 413 to sense parallel loads 438, 439.

Parallel loads 438, 439 are as described in connection with the circuit of FIG. 2. Driver op amp 411 is controlled by the voltages at nodes 448 and 449 of parallel loads 438, 439. Within op amp 411, n-type transistor N_{POS} is connected in series with p-type transistor P_{DIO} Also, n-type transistor N_{NEG} is connected in series with p-type transistor P_{SRC}. Transistors N_{POS} and N_{NEG} are gated by control output connections 448 and 449, thus providing the NMOS inputs in control circuit 413. The two n-type transistors N_{POS} and N_{NEG} connected in series to respective p-type transistors P_{DIO} and P_{SRC} establish parallel circuits 451, 452. The gating of transistors N_{POS} and N_{NEG} by control output connections 448 and 449 results in parallel circuits 451, 452 sensing parallel loads 438, 439 in the manner described in connection with op amp 233 (FIG. 2).

A difference node NDIFF is at the ground side of the two n-type transistors N_{POS} and N_{NEG}. The two n-type transistors N_{POS} and N_{NEG} in turn receive source current from the two p-type transistors P_{DIO} and P_{SRC}. Transistor N_{SRC1} is interposed between difference node NDIFF and ground (V_{SS}). Difference node NDIFF is therefore established by the balance of voltages across transistor N_{SRC1} and parallel circuits 451, 452. This is different from the configuration of the op amp 233 (FIG. 2) which uses PMOS inputs (P_{POS} and P_{NEG} of FIG. 2).

As a result of control circuit 413 in driver op amp 411 being referenced to ground (V_{SS}), an output control node V_{OUT} is established according to corresponding NMOS parameters based on transistors N_{POS} and N_{NEG} connected to nodes 448 and 449 of parallel loads 438, 439. This eliminates the prior art problem of the minimum voltage at low temperature but presents a control output referenced to ground. This is addressed by providing a low-gain stage 431 comprised of a first output transistor 433, a diode-connected transistor 436, and a second output transistor 441. Low-gain stage 431 allows the control of V_{OUT} to be referenced to source voltage V_{CC} and also allows the bandgap design of FIG. 2, implemented with parallel loads 438, 439, to be used. V_{OUT} is then able to control a bandgap generator stage 490. The bandgap generator stage 490 functions in a manner similar to bandgap generator stage 290 described in connection with FIG. 2.

In low-gain stage 431, an output node 444 provides an output to first output transistor 433. The low end of first output transistor 433 is diode-connected at transistor 436 to ground (V_{SS}) and is used to gate second output transistor 441. Second output transistor 441 and a diode-connected output transistor 446 are used to provide the output of core stage 400. This provides the equivalent of a PMOS control, but uses an NMOS configuration in which n-type transistors N_{POS} and N_{NEG} are gated by control output connections 448 and 449.

Node NDIFF therefore is referenced to ground, rather than to the source voltage (V_{CC}). In order to control op amp 411 so that op amp 411 responds to V_{OUT} referenced to V_{CC}, a source input circuit 461 is used in combination with transistor N_{SRC}. Source input circuit 461 includes transistor P_{SRC2} connected in series with transistor N_{SRC0}, and transistor N_{SRC0} is diode-connected through intermediate node 471. Transistor P_{SRC2} is sourced to V_{CC} and gated by V_{OUT} in a manner similar to transistor P_{SRC2} in op amp 233 of FIG. 2. The low side of transistor P_{SRC2} establishes intermediate node 471, although in this configuration, transistor P_{SRC2} is not connected in series with the parallel circuits 451, 452 established by N_{POS}, P_{DIO}, and N_{NEG}, P_{SRC}. Instead, current on the low side of transistor P_{SRC2} passes through its series connection with transistor N_{SRC0}. Node 471, between transistors P_{SRC2} and N_{SRC0}, is used to gate transistor N_{SRC1}. This allows transistor N_{SRC1} to control current through node NDIFF according to voltage at node 471. Therefore, the control of transistor N_{SRC1} is effected according to the balance of transistors P_{SRC2} and N_{SRC0}. As a result, transistor N_{SRC1} is controlled by V_{CC} and V_{OUT} in a manner analogous to the control of node PDIFF of op amp 233 (FIG. 2).

The combination of source input circuit 461 and low-gain stage 431 results in op amp 411 responding to V_{CC} and V_{OUT} with n-type transistor inputs at N_{POS} and N_{NEG}, and providing a control of V_{OUT} in response to sensed loads 438, 439. This permits op amp 411 to function at low temperature according to the parameters established by the NMOS circuitry, while receiving control inputs and providing an output that correspond to those afforded by the PMOS inputs of the prior art circuit. The present circuit provides a further advantage of controlling transistor N_{SRC1} according to voltage parameters that are substantially independent of the parallel circuits 451, 452. As temperature across the bipolar transistors Q0 and Q1 changes, the balance of control outputs 448, 449 changes, thereby differentially controlling transistors N_{POS} and N_{NEG} such that the voltage at node 444 decreases with an increase in temperature and increases with a decrease in temperature. This is opposite from the effect on node 271 of FIG. 2. As voltage changes at node 444, an opposite change is effected at the gate to transistor 441. As a result, voltage at the gate of transistor 441 increases with an increase in temperature and decreases with a decrease in temperature. This is the same as occurs with the voltage applied to transistor N_{OUT} in FIG. 2.

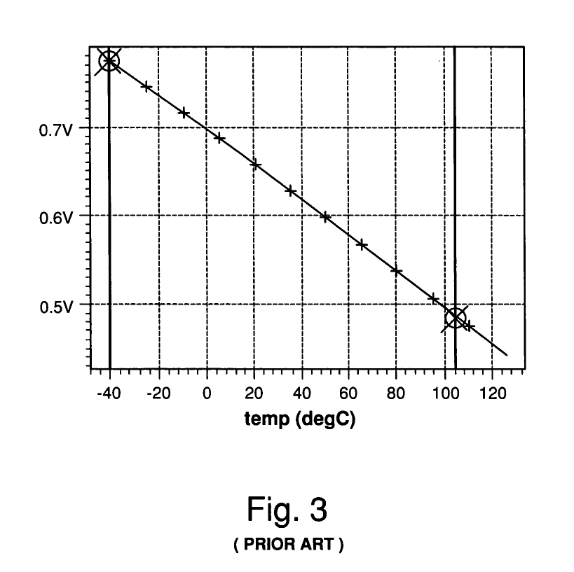

Referring again to FIG. 3, the operation of the PNP devices Q0, Q1 remains as depicted in the graph, but because of the operation of op amp 411 with NMOS inputs N_{POS} and N_{NEG}, the minimum voltage across the PNP devices (PNPₘᵢₙ) becomes:
PNPₘᵢₙ=V_{NGS}+V_{NSAT} (equation 6)
where:
V_{NGS} is the gate-to-source voltage across transistors N_{POS} and N_{NEG}, and
V_{NSAT} is the saturation voltage of transistor N_{SRC1}.
   In terms of the circuit, equation 6 becomes:
   PNPₘᵢₙ=V_{CC min} (equation 7)

Applying the values from the devices in FIG. 2, we have:
V_{NGS}=0.26 v
V_{NSAT}=0.05 v

Applying these values from the devices in FIG. 2 to the circuit of FIG. 4, the minimum voltage at the low-temperature end of the graph of FIG. 3 (−40°) would be:
PNPₘᵢₙ=V_{CC min}=0.26 v+0.05 v=0.31 v (equation 8)

When V_{CC}=1.0 v, this leaves a margin of close to 0.7 volts at the lower end of the temperature range. The margin decreases with increase in temperature, but it is anticipated that the maximum operating temperature will be below the temperature at which the voltage saturation margin will cause the circuit to not provide the desired results. Therefore, if the circuit operates at a maximum temperature of 105° and does not work properly at 125°, the circuit has a 20° margin of operational stability at the upper temperature range. As a result, the bandgap generator generates either a constant current or a constant voltage over a predetermined range of voltage and temperature.

Variations can be made to the specific circuit depicted. For example, it is possible to use a single transistor in lieu of transistors P_{SRC0} and P_{SRC1}, such that the single transistor drives both loads 438 and 439. The particular configuration of low-gain stage 431 can be modified, while still achieving the results of controlling V_{OUT}. Likewise, the control of NDIFF by control of transistor N_{SRC1} can be achieved differently by a circuit responsive to one or both of V_{CC} and V_{OUT}.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It will be further understood that various changes in the details, materials, and arrangements of the parts that have been described and illustrated in order to explain the nature of this invention may be made by those skilled in the art without departing from the scope of the invention as expressed in the following claims.

We claim:

1. Circuitry comprising a driver op amp (e.g., 411) adapted to receive at least two op-amp inputs (e.g., 448, 449) and generate an op-amp output voltage (e.g., V_{OUT}), wherein the driver op amp comprises:
a first circuit (e.g., 413) responsive to the op-amp inputs and adapted to adjust voltage at a difference node (e.g., NDIFF) in the driver op amp, wherein the difference node is on a low-voltage side of the op-amp inputs; and
a second circuit (e.g., 431) adapted to convert an output (e.g., 444) of the first circuit to the op-amp output voltage referenced to a high reference voltage (e.g., V_{CC}).

2. The invention of claim 1, further comprising a pair of parallel reference loads (e.g., 438, 439) adapted to generate the op-amp inputs.

3. The invention of claim 2, wherein:
a first one of the parallel reference loads comprises a first transistor (e.g., P_{SRC0}) gated by the op-amp output voltage and in a series connection with a first bipolar device (e.g., Q0) and a further resistive device;
a second one of the parallel reference loads comprises a second transistor (e.g., P_{SRC1}) gated by the op-amp output voltage and in a series connection with a second bipolar device (e.g., Q1);
the first and second bipolar devices have device parameters that result in differential device impedances, with the differential device impedances compensated for by the further resistive device; and
the inputs from the parallel reference loads are provided from connections between the first and second transistors and the first and second bipolar devices.

4. The invention of claim 3, further comprising:
a bandgap generator receiving the op-amp output voltage and adapted to convert the op-amp output voltage to a bandgap voltage; and
the bandgap generator comprising a further transistor gated by the op-amp output voltage and in a series connection with a further bipolar device.

5. The invention of claim 2, wherein the parallel reference loads differentially respond to temperature to provide the op-amp inputs to control the driver op amp according to the differential response to temperature.

6. The invention of claim 1, wherein the driver op amp is adapted to generate the op-amp output voltage in response to a difference between the op-amp inputs.

7. The invention of claim 1, wherein the driver op amp further comprises a source input circuit (e.g., 461) operatively connected between the high reference voltage and a low reference voltage (e.g., V_{SS}) and responsive to the op-amp output voltage to gate current between the difference node and the low reference voltage to provide a further adjustment to the voltage at the difference node.

8. The invention of claim 7, further comprising a pair of parallel reference loads (e.g., 438, 439) adapted to generate the op-amp inputs.

9. The invention of claim 1, wherein the first circuit comprises NMOS devices (e.g., N_{POS} and N_{NEG}) adapted to receive the op-amp inputs, with the difference node on the low-voltage side of the NMOS devices.

10. The invention of claim 9, further comprising a pair of parallel reference loads (e.g., 438, 439) adapted to generate the op-amp inputs.

11. The invention of claim 9, wherein the first circuit further comprises:
PMOS devices (e.g., P_{DIO} and P_{SRC}) connected in series between the NMOS devices and the high reference voltage; and
an other transistor connected between the NMOS devices and the low reference voltage.

12. The invention of claim 1, wherein the second circuit comprises:
an output transistor (e.g., 441) connected in series with a source load device (e.g., 446) that is diode-connected to the op-amp output voltage; and
a pair of transistors (e.g., 433, 436) connected between the high and low reference voltages, one of the transistors gated by the output (e.g., 444) of the first circuit, and the other of the transistors being diode-connected to an intermediate node between the transistors, wherein the intermediate node provides a control voltage to gate the output transistor.

13. The invention of claim 1, further comprising a bandgap generator adapted to convert the op-amp output voltage to a bandgap voltage.

14. The invention of claim 13, further comprising a current generator adapted to convert the bandgap voltage to an output current.

15. Circuitry comprising a driver op amp (e.g., 411) adapted to receive at least two op-amp inputs (e.g., 448, 449) and generate an op-amp output voltage (e.g., V_{OUT}), wherein the driver op amp comprises:
first means (e.g., 413), responsive to the op-amp inputs, for adjusting voltage at a difference node (e.g., NDIFF) in the driver op amp, wherein the difference node is on a low-voltage side of the op-amp inputs; and
second means (e.g., 431) for converting an output (e.g., 444) of the first means to the op-amp output voltage referenced to a high reference voltage (e.g., V_{CC}).
